(19) United States
(12) Patent Application Publication
(10) Pub. No.: US 2020/0278971 A1
(43) Pub. Date: Sep. 3, 2020

(54) DOCUMENT RETRIEVAL APPARATUS AND DOCUMENT RETRIEVAL METHOD

(71) Applicant: FANUC CORPORATION, Yamanashi (JP)

(72) Inventors: Yuji TUBOGUCHI, Yamanashi (JP); Masao KAMIGUCHI, Yamanashi (JP); Noriaki NEKO, Yamanashi (JP)

(73) Assignee: FANUC CORPORATION, Yamanashi (JP)

(21) Appl. No.: 16/780,568

(22) Filed: Feb. 3, 2020

(30) Foreign Application Priority Data
Feb. 28, 2019 (JP) 2019-036257

(51) Int. Cl. G06F 16/2455; G06Q 10/10; G06F 16/248; G06F 16/242

(52) U.S. Cl. CPC G06F 16/24558; G06F 16/243; G06F 16/248; G06Q 10/10

(57) ABSTRACT

The present invention is intended to provide a document retrieval apparatus and a document retrieval method that are capable of accurately retrieving a desired portion from a document. The document retrieval apparatus 1 includes: a query receiving unit 11 configured to receive a query; a search keyword extraction unit 12 configured to extract a search keyword group from the query; a first search unit 13 configured to search a document 221 stored in a document storage area 22 using the search keyword group, and thereby to retrieve a first search result; a second. search unit 14 configured to, if the search keyword group includes a general word 211 stored in a general word storage area 21, search the document 221 using a second search keyword group corresponding to the search keyword group with the general word 211 excluded, and thereby to retrieve a second search result; and a search result presentation unit 16 configured to output the first search result and. the second search result if the search keyword group includes the general word 211, and to output the first search result if the search keyword group does not include the general word 211.

This application is based on and claims the benefit of priority from Japanese Patent Application No. 2019-036257, filed on 28 Feb. 2019, the content of which is incorporated herein by reference.

### BACKGROUND OF THE INVENTION

### Field of the Invention

The present invention relates to a document retrieval apparatus and a document retrieval method.

### Related Art

According to the known art, when using a product such as an industrial machine and an electronic device, an operator, a manager and other users refer to various types of documents including an instruction manual and a maintenance manual as necessary. A document of this type contains technical details related to a large number of components and portions (e.g., a controller, software and machine parts) of the subject product. It is therefore difficult to find a desired description even with reference to a table of contents or an index. To address this problem, digitization of documents has been promoted and full text search technologies have been developed. However, it is still difficult to find a description suiting a purpose in search results extracted through a keyword search.

For example, according to a known technique to create search keywords, a sentence is divided into words, an unnecessary word dictionary is used to exclude words that are unnecessary as search keywords from the words resulting from the division, and the remaining words are adopted as the search keywords (see, for example, Patent Document 1). For instance, expressions such as “how to operate xxxx” or “operation procedure of xxxx” often appear in an instruction manual of a device. In this case, the words “operation”, “how to operate” and “operation procedure”, which are general terms, are excluded as unnecessary words or the like, and are not adopted as search keywords. As a result, “xxxx” is substantially used as the search keyword in response to a query such as “I want to know the operation procedure of xxxx”. Consequently, if the instruction manual to be searched contains expressions including “xxxx” such as “how to adjust xxxx”, all of the expressions are retrieved as the search results. Since “xxxx” is the substantial search keyword, even if the instruction manual describing the “operation procedure of xxxx”, which is the retrieval target, is retrieved as a search result, the instruction manual is not necessarily listed as the top item of the search results. Specifically, in a case where in response to a query such as “I want to know the operation procedure of xxxx”, many instruction manuals containing the word “xxxx”, such as an instruction manual containing “procedure for adjusting xxxx” and “procedure for setting xxxx”, are retrieved in addition to the instruction manual containing “operation procedure of xxxx”, it may be difficult to find the desired instruction manual from the list of the search results even though it is included in the list.

Patent Document 1: Japanese Unexamined Patent Application, Publication No. H06-309362

### SUMMARY OF THE INVENTION

There has been a demand for a document retrieval apparatus which can efficiently retrieve and present a document desired by a user in response to the user's query made in natural language in order to search various documents, without the user's having to be mindful of whether to use a general term as a search keyword.

A first aspect of the present invention relates to a document retrieval apparatus including: a document storage area configured to store a plurality of documents; a general word storage area configured to store a word preset as a general word); a query receiving unit configured to receive a query from a user; a search. keyword extraction unit configured to extract a search keyword group consisting of at least one keyword from the query; a first search unit configured to search. the documents stored in the document storage area using a search expression including each of the at least one keyword included in the search keyword group, and thereby to retrieve a first search result; a second search unit configured to, if the search keyword group includes the general word, search the documents stored in the document storage area using a search expression including each of at least one keyword included in a second search keyword group corresponding to the search keyword group with entirety of the general word excluded, and thereby to retrieve a second search result; and a search result presentation unit configured to output the first search result and the second search result if the search keyword group includes the general word, and to output the first search result if the search keyword group does not include the general word.

A second aspect of the present invention relates to the document retrieval apparatus described in the first aspect, the document retrieval apparatus further including: a third search unit configured to, if the search keyword group includes the general word, search the documents stored in the document storage area using a search expression including each of at least one keyword included in a third search keyword group consisting solely of the general word included in the search keyword group, and thereby to retrieve a third search result, wherein the search result presentation unit is further configured to output the first search result, the second search result and the third search result if the search keyword group includes the general word, and to output the first search result if the search keyword group does riot include the general word.

A third aspect of the present invention relates to a document retrieval method executed by a computer, the method including: a query receiving step of receiving a query from a user; a search keyword extraction step of extracting a search keyword group consisting of at least one keyword from the query; a first search step of searching a plurality of documents stored in a document storage area using a search expression including each of the at least one keyword included in the search keyword group, and retrieving a first search result; a second search step of searching the documents stored in the document storage area and retrieving a second search result, the second search step being performed if the search keyword group includes a word preset as a general word and stored in a general word storage area, the second search step being performed with use of a search expression including each of at least one keyword included in a second search keyword group corresponding to the search keyword group with entirety of the general word excluded; and a search result presenting step of outputting the first search result and the second search result if the search keyword group includes the general word, or of outputting the first search result if the search keyword group does not include the general word.

According to one embodiment of the present invention, when making a query in a natural language to search various documents, the user does not need to be mindful of whether to use a general word as a search keyword, and a document desired by the user can be presented with efficiency.

### BRIEF DESCRIPTION OF THE DRAWINGS

FIG. 1 is a block diagram showing a functional configuration of a document retrieval apparatus according to an embodiment;

FIG. 2 is a diagram showing an example of a user interface screen that a query receiving unit 11 according to an embodiment provides for queries;

FIG. 3 is a diagram showing an example of a user interface screen for presenting search results provided by a search result presentation unit 16 according to an embodiment;

FIG. 4 is a block diagram showing a functional configuration of a document retrieval apparatus according to an embodiment;

FIG. 5 is a diagram showing an example of a user interface screen for presenting search results provided by a search result presentation unit 16 according to an embodiment;

FIG. 6 is a flowchart showing a search method performed by a document retrieval apparatus according to an embodiment, the document retrieval apparatus including a first search unit 13 and a second search unit 14; and

FIG. 7 is a flowchart showing a search method performed by a document retrieval apparatus according to an embodiment, the document retrieval apparatus including a first search unit 13, a second search unit 14 and a third search unit 15.

### DETAILED DESCRIPTION OF THE INVENTION

### First Embodiment

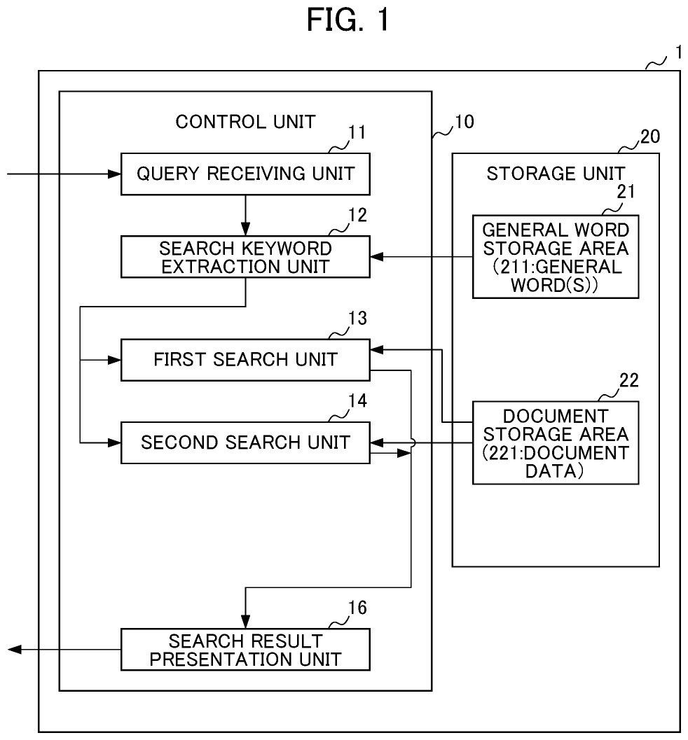

A first embodiment, which is an example of embodiments of the present invention, will be described below. FIG. 1 is a block diagram showing a functional configuration of a document retrieval apparatus 1 according to the present embodiment. The document retrieval apparatus 1 is an information processing apparatus that includes various interfaces for input/output and for communications, in addition to a control unit 10 and a storage unit 20. The document retrieval apparatus 1 may be implemented as a variety of electronic devices such as a server, a personal computer, a smart phone, a tablet terminal, a game console, a navigation device, and a household appliance.

The control unit 10 controls the whole document retrieval apparatus 1, and carries out various functions of the present embodiment by appropriately reading and executing various programs stored in the storage unit 20. The control unit 10 may be a CPU.

The storage unit 20 is a storage area where various programs for causing a hardware group to function as the document retrieval apparatus 1, various data and the like are stored. The storage unit 20 may be, for example, a ROM, a RAM, a flash memory and a hard disk drive (HDD). More specifically, the storage unit 20 has, in addition to various search programs for causing the control unit 10 to carry out the various functions of the present embodiment, a general word storage area 21 as a general word storage unit for storing a general word 211 preset as a general word, a document storage area 22 as a document storage unit for storing document data 221 as a document to be searched, and other areas. Here, a general word as used herein is defined as a word that does not refer to, for example, a particular matter or case, but is widely recognized and commonly used. The general word is preset in the present invention. For example, in a case where a document to be searched is a written explanation, “explanation” and the like corresponds to the general words. In a case where a document to be searched is an instruction manual, “handling”, “operation”, “operation procedure” and the like correspond to the general words. Note that these data (i.e., the general word 211 and the document data 221) may be stored outside the document retrieval apparatus 1. For example, the general word storage area 21 and/or the document storage area 22 may be provided at a location physically separated from the document retrieval apparatus 1, and read/write (input/output) may be performed through communication with the document retrieval apparatus 1 via a network.

The control unit 10 includes a query receiving unit 11, a search keyword extraction unit 12, a first search unit 13, a second search unit 1-1 and a search result presentation unit 16, and causes these functional units to operate to output search results retrieved from the document data, in response to a query from a user.

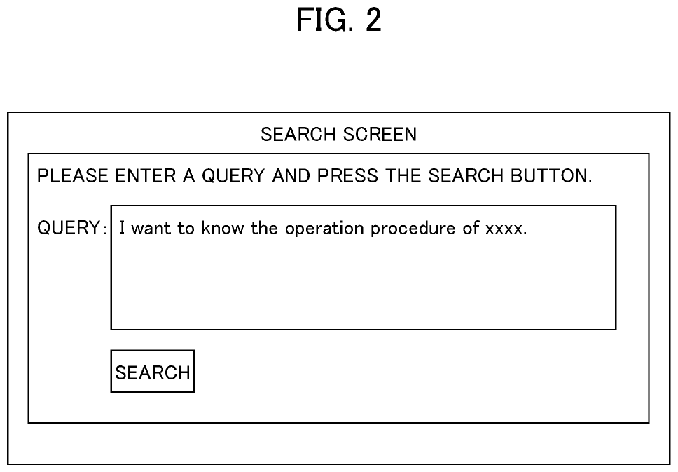

The query receiving unit 11 receives, from a user, a query according to which a document as a search target is searched. The query receiving unit 11 may receive, for example, a character input via a keyboard or the like, a character input resulting from speech transcription, and/or a character input resulting from handwritten character recognition. Any method may be applied to the query receiving unit 11. In addition, the query receiving unit 11 may receive a query inputted in the form of a natural sentence by a user. FIG. 2 shows an example of a user interface screen that the query receiving unit 11 provides for queries. As shown in FIG. 2, a user can input a query in a natural sentence (e.g., “I want to know the operation procedure of xx”).

The search keyword extraction unit 12 extracts a search. keyword group consisting of at least one keyword from the user's query received by the query receiving unit 11. The search keyword extraction unit 12 may use, for example, a technique such as morphological analysis so as to extract keywords by dividing a query sentence into words and/or compounds such as idioms. The search keyword extraction unit 12 may extract the keywords by dividing a compound. For example, the search keyword extraction unit 12 can extract, from a query that reads as “I want, to know the operation procedure of xxxx”, a search keyword group consisting of “xxxx” and “operation procedure”. Alternatively, the search keyword extraction unit 12 may extract a search keyword group consisting of “xxxx”, “operation” and “operation procedure”. Alternatively, the search keyword extraction unit 12 may extract a search keyword group consisting of “xxxx”, “operation”, “procedure” and “operation procedure”. In addition, the search keyword extraction unit 12 may use an unnecessary word dictionary to determine, for example, the words (verbs) of “want” and “know” as unnecessary words, thereby excluding the unnecessary words from the search keyword group.

The first search unit 13 searches the document data 221 stored in the document storage area 22 using a search expression including each of the at least one keyword included in the search keyword group extracted by the search keyword extraction unit 12, and thereby retrieves a first search result. Here, the first search unit 13 may conduct, in response to a user's query, a search using a search expression including each of at least one keyword that is appropriate for obtaining a desired search result. For example, an a case where the search keyword extraction unit 12 extracts a search keyword group consisting of “xxxx” and “operation procedure” from a query that reads as “I want to know the operation procedure of xxxx”, a desired search result can be retrieved through a search for “xxxx” and “operation procedure” with the AND condition. Alternatively, in a case where a search keyword group consisting of “xxxx”, “operation” and “operation procedure” is extracted, a set which includes a result of a search for “xxxx” and “operation procedure” with the AND condition and a result of a search for “xxxx” and “operation” with the AND condition can be retrieved. Consequently, the first search result includes a data item containing both of the keywords of “xxxx” and “operation” or both of the keywords of “xxxx” and “operation procedure”. Thus, the possibility that the first search result includes the desired data item is increased.

If at least one general word is included in the search keyword group extracted by the search keyword extraction unit 12, the second search unit 14 searches the document data 221 stored in the document storage area 22 using a search expression including each of at least one keyword included in a second search keyword group that corresponds to the search keyword group with each of the at least one general word excluded, and thereby retrieves a second search result. For example, if “operation” and “operation procedure” are stored in the general word storage area 21 as the general words highly frequently appearing in the document, the second search unit 14 searches the document using the second search keyword group that corresponds to the search keyword group excluding the general words, i.e., “operation” and “operation procedure”, and. that consists of “xxxx”. The second search unit 14 then retrieves a search result as the second search result. The second search result may include, for example, a data item containing an expression. such as “how to handle xxxx”. Thus, the second search result may include a desired data item in which the retrieval target is expressed in different words or a data item with contents similar to the retrieval target. In other words, a data item containing an expression or words that is/are similar to, but not synonymous with, the retrieval target may be included in the second search result.

If at least one general word is included in the search keyword group extracted by the search keyword extraction unit 12, the search result presentation unit 16 outputs the first search result retrieved by the first search unit 13 searching the document using each of the at least one keyword of the search keyword group, and the second search result retrieved through the search of the document using the second search keyword group corresponding to the search keyword group with the at least one general word excluded. Here, outputting the first search result and/or the second search result means, but is not limited to: outputting the search result(s) to a display unit (not shown) of the document retrieval apparatus 1 or to a display unit (not shown) of a terminal (not shown) via a network (e.g., displaying the search result(s) on a screen) and outputting the search result(s) to, for example, a file. As a manner of outputting a data item of the document data 221 that is retrieved as the search result, the search result presentation unit 16 may output link information for the data item of the document data 221 in the document storage area 22. Alternatively, the search result presentation unit 16 may attach the data item of the document data 221.

When outputting these search results, the search result presentation unit 16 may present the first search result at a highest. level. Outputting the first search result at the highest level in this manner makes it easier for the user to find the desired search result. Here, outputting a search result at the highest level means that, for example, the search result heads a set of search results in a case where the set of search results is output to a display unit (not shown) of the document retrieval apparatus 1 or a display unit (not shown) of a terminal (not shown) via a network (e.g., in a case where the set of search results is displayed on a screen). More specifically, for example, if the set of search results is displayed from top to bottom on a screen, it is meant that the search result is displayed. at the uppermost position. If the set of search results is displayed from left to right on a screen, it is meant that the search result is displayed at the leftmost position. Further, in a case where the set of search results is output to a file, it is meant that for example, the search result is output so as to head the file, or that the search result is displayed first when the contents of the file are displayed.

If the first search result is included in the second search result, the search result presentation unit 16 may exclude the first search result from the second search result when outputting the second search result. This makes it possible to prevent the same data item of the document data 221 from being displayed in an overlapping manner, and allows the user to find the desired search result with efficiency.

Note that if no general word is included in the search keyword group extracted by the search keyword extraction unit 12, the search result presentation unit 16 outputs only the first search result retrieved by the first search unit 13 searching the document using all the keywords of the search keyword group.

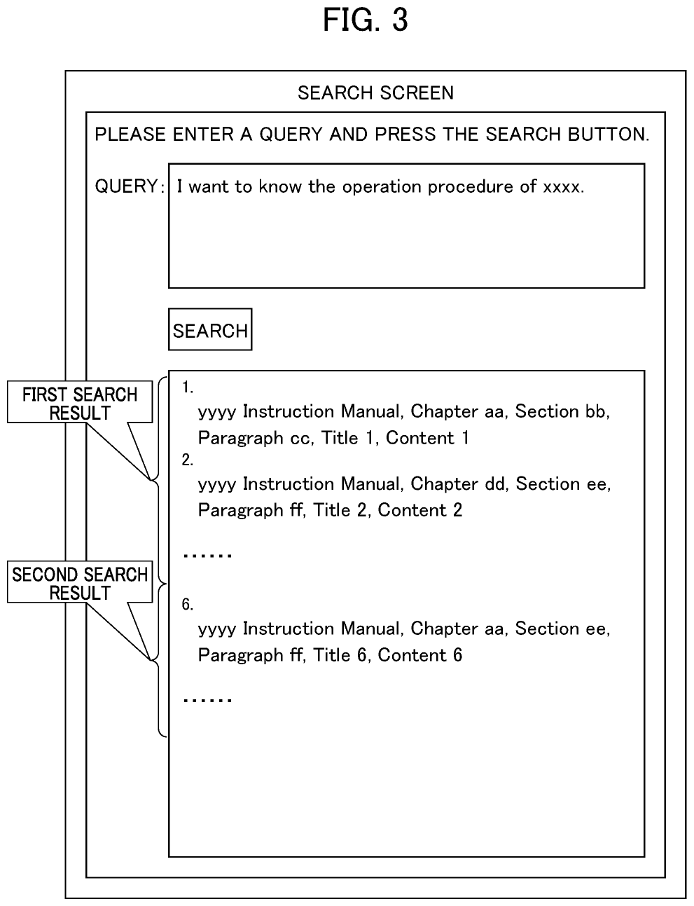

FIG. 3 shows an example of a user interface screen for presenting search results provided by the search result presentation unit 16. FIG. 3 shows, as an example, search results from which overlapping of search results has been eliminated. In other words, FIG. 3 shows the second search result with the exclusion of the first search result since the first search result previously included therein has been excluded at the time of outputting of the second search result. In the example shown in FIG. 3, five items of the first search result and three items of the second search result have been retrieved. In the search results shown in FIG. 3, item numbers 1 to 5 belong to the first search result and item numbers 6 to 8 belong to the second search result.

In FIG. 3, “yyyy Instruction Manual, Chapter aa, Section bb, Paragraph cc, Title 1” displayed as item number 1 of the first search result is intended to indicate the source of the search result in the document data 221. Here, the “yyyy Instruction Manual” indicates the title of the document, “Chapter aa, Section bb, Paragraph cc” indicates a portion (chapter/section/paragraph) in which the retrieval target can be described in the “yyyy instruction Manual”, and the “Title 1” indicates the title of “Paragraph cc of Section bb of Chapter aa”. When presenting the portion in which the retrieval target, can be described, the search result presentation unit 16 may indicate the page number of the document data 221, instead of the chapter/section/paragraph indication such as “Chapter aa, Section bb, Paragraph cc”, or may indicate the chapter/section/paragraph indication and the page number in combination. Further, when the chapter/section/paragraph indication is presented, “Chapter aa, Section bb, Paragraph cc” may be denoted by “aa-bb-cc”, “aa-bb-cc-”, “aa.bb.cc”, “aa.bb.cc.”, “aa bb cc”, “aa_bb_cc”, “aa_bb_cc_”, with punctuation marks such as “-”, “.”, “_” and the like put between. the chapter number and the section number, between the section number and the paragraph number, or after the paragraph number.

When presenting the title of a paragraph of a section of a chapter corresponding to the retrieved item of the document data 221, the search result presentation unit 16 may add the title of a precedence chapter or the title of a precedence section. For example, suppose that the document data 221 includes contents with the following chapter title, section title and paragraph title.

Chapter 1 AAAA Chapter 1, Section 1, bbbb Chapter 1, Section 1, Paragraph 1, Operation Procedure

Chapter 2 CCCC Chapter 2, Section 1, dddd Chapter 2, Section 1, Paragraph 1, Operation Procedure

If these contents are presented in the manner described above, the title of Paragraph 1 of Section 1 of Chapter 1 and the title or Paragraph 1 of Section 1 of Chapter 2 are the same, i.e., “Operation Procedure”. Therefore, if the search result presentation unit 16 presents only the paragraph title as the source of the data item, Chapter 1, Section 1, Paragraph 1 is indicated as “yyyy Instruction Manual, Chapter 1, Section 1, Paragraph 1, Operation Procedure” and Chapter 2, Section 1, Paragraph 1 is indicated as “yyyy Instruction Manual, Chapter 2, Section 1, Paragraph 1, Operation Procedure”. Thus, there is a possibility that the user has difficulty in understanding to what the operation procedure contained in the data item is related. In such a case, since a chapter title or a section title often indicates the target of the operation, addition of the chapter title or the section title to the indication of the paragraph title may make it easy to understand for what the operation procedure is. Therefore, when presenting the title of Paragraph 1 of Section 1 of Chapter 1, the search result presentation unit 16 may add the title of Chapter 1 or the title of Section 1 of Chapter 1, and may present it as “bbbb operation procedure” or “AAAA bbbb operation procedure” or the like. Further, when adding a chapter title or a section title, the search result presentation unit 16 may put a space or a punctuation mark such as “,” between the chapter title and the section title to separate the titles from each other. Likewise, when presenting the title of a section, the search result presentation unit 16 may add the title of the precedence chapter of the section.

Referring to FIG. 3, “Content 1” displayed at the first item of the search results represents the content of “yyyy Instruction Manual, Chapter aa, Section bb, Paragraph cc”. When presenting the description of the search result retrieved from the document data 221, the search result presentation unit 16 does not need to present the entire content of the portion retrieved as the search result, and may present a part of the portion, for example, a heading part or the like. In FIG. 3, for example, the search result presentation unit 16 may attach a link for “yyyy instruction Manual, Chapter aa, Section bb, Paragraph cc” of the document data 221, to the indication of “yyyy Instruction. Manual, Chapter aa, Section bb, Paragraph cc” or the indication of “yyyy Instruction Manual, Chapter aa, Section bb, Paragraph cc, Title 1” of the first item of the search results. Alternatively, the search result presentation unit 16 may display a button with a link set thereto, together with the search result. Alternatively, the portion denoted by “yyyy instruction Manual, Chapter aa, Section bb, Paragraph cc” may be formed into an attached file, and the search result presentation unit 16 may display a button for opening the attached file, together with the search result. The foregoing description. has been directed to the configuration of each of the functional units of the document retrieval apparatus 1 according to the first embodiment exemplified as the present embodiment.

### Second Embodiment

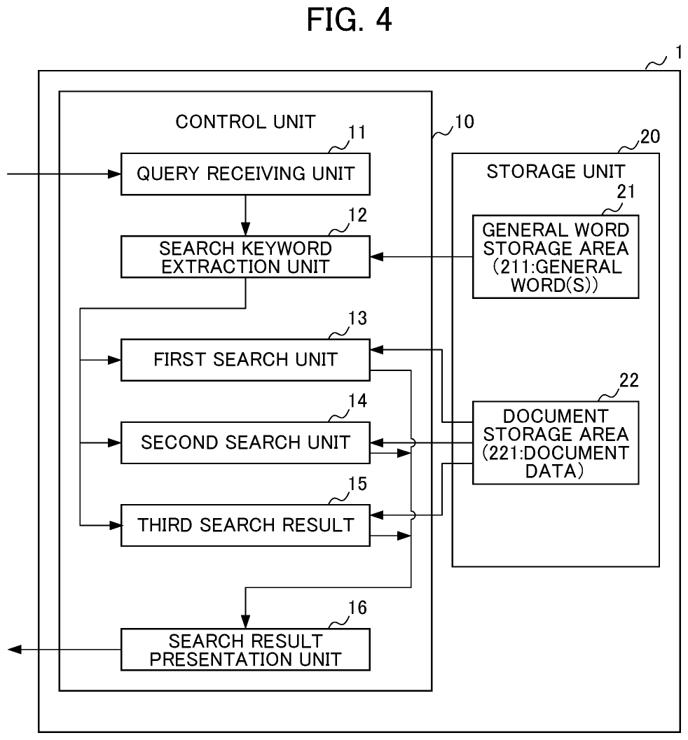

The document retrieval apparatus 1 according to the first embodiment described above includes the first search unit 13 and the second search unit 14. However, the functional units included in the document retrieval apparatus 1 are not limited to those of the first embodiment. For example, the document retrieval apparatus 1 may include a third search unit 15 in addition to the first search. unit 13 and the second search. unit 14. FIG. 4 is a block diagram showing a functional configuration of a document retrieval apparatus 1 according to a second embodiment. Functional units different from the functional units of the first. embodiment, namely, the third search. unit 15 and a search result presentation unit 16 will be described below, while description of the other functional units that are the same as those of the first embodiment will be omitted.

If at least one general word is included in a search keyword group extracted by a search keyword extraction unit 12, the third search unit 15 searches document data 221 stored in. a document storage area 22 using a search expression including each of at least one keyword included in a third search keyword group consisting solely of the at least one general word included in the search keyword group, and thereby retrieves a third search result. For example, the third search unit 15 searches the document. using the third search keyword group consisting solely of the general words (e.g., “operation” and “operation. procedure”) included in the search keyword group extracted by the search keyword extraction unit 12 from. the above-described query reading as “I want to know the operation procedure of =xxxx”, and thereby retrieves a search result as the third search result. Specifically, the third search unit 15 conducts a search using “operation” and “operation procedure” with OR condition, and retrieves search result as the third search result. For example, if the number of hits is 0 in both the first search result and the second search result, there is a possibility that the keywords included in the search keyword group extracted by the search keyword extraction unit 12 are not appropriate. Therefore, output of the third search result retrieved using only the general words allows the user to correct query words with reference to the third search result and to make a query again. For example, in the case of a query reading as “I want to know the operation procedure of xxxx”, if there is no data item containing the keyword “xxxx” in the document to be searched, the number of hits is 0 in both the first search result and the second search result. In this case, there is a possibility that the keyword “xxxx” is not appropriate. Therefore, outputting, as the third search result, the search result retrieved using “operation” and “operation procedure” allows the user to make a query again by correcting the query words “I want to know the operation procedure of xxxx” with reference to the third search result. In order to search the document data 221, various set operations are combined. In particular, if the search keyword group extracted by the search keyword extraction unit 12 consists of a plurality of keywords, the document is not necessarily searched using the keywords with AND condition. For this reason, the first search result is not always equal to the AND set of the “second search result” and the “third search result”. For example, {result set of “operation procedure of xxxx” and “adjustment procedure of xxxx” or “operation procedure of yyyy”} (the “first search result”) is not always equal to the AND set of {result set of “xxxx” or “yyyy”} (the “second search result”) and {result set of “operation procedure” or “adjustment procedure”} (the “third search result”).

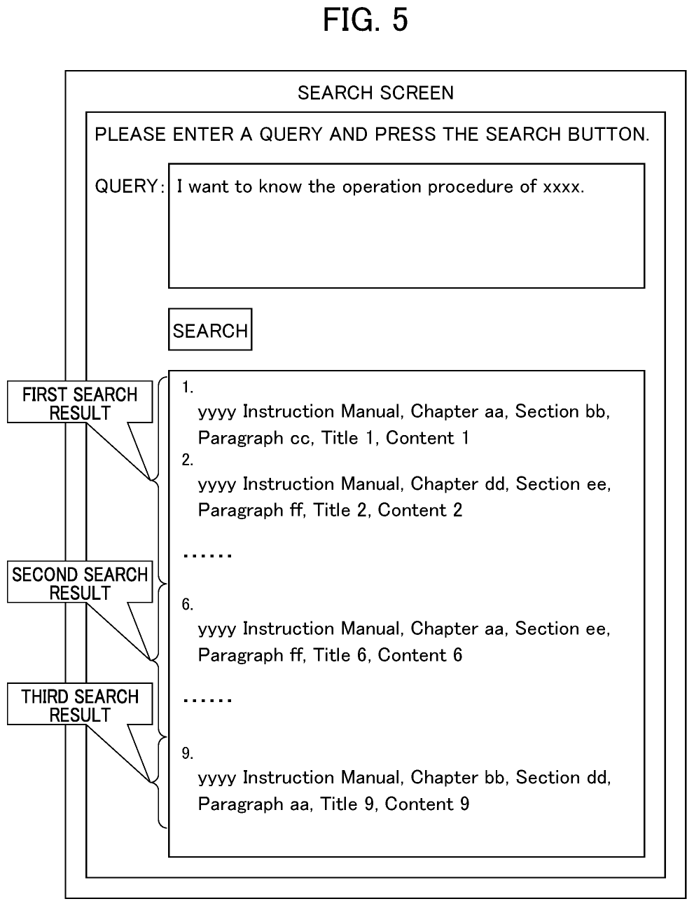

In the second embodiment, if at least one general word is included in the search keyword group extracted by the search keyword extraction unit 12, the search result presentation. unit 16 outputs: the first search result retrieved by the first search unit 13 searching the document using each of the at least one search keyword of the search keyword group; the second search result retrieved through a search of the document using the second search keyword group corresponding to the search keyword group with the at least one general word excluded; and the third search result retrieved through a search of the document using the third search keyword group consisting solely of the at least one general word included in the search keyword. group. In this case, as in the first embodiment, when outputting these search results, the search result presentation unit 16 may present the first search result at the highest level, followed by output of the second search result and the third search result in this order. Outputting the first search. result at the highest level in this manner allows the user to easily find the desired search result. Further, if the first search result is included in the second search result, the search result presentation unit 16 excludes the first search result from the second search result when outputting the second search result. In this case, if the first search result is included in the third search result, the search result presentation unit 16 may also exclude the first search result, from the third search result when outputting the third search result. This makes it possible to prevent the same data item of the document data 221 from being displayed in an overlapping manner, and allows the user to find the desired search result with more efficiency. FIG. 5 is a diagram showing an example of a user interface screen for presenting search results provided by the search result presentation unit 16. FIG. 5 shows, as an example, search results from which overlapping of search results has been eliminated. Specifically, the second search result and the third search result may each include the first search result. In this case, as shown in FIG. 5, the second search result is displayed with the first search result excluded at the time of outputting of the second search result, and the third search result is displayed with the first search result excluded at the time of outputting of the third search result. FIG. 5 shows an example in which five items of the first search result, three items of the second search result and one item of the third search result have been retrieved. In the search results shown in FIG. 5, item numbers 1 to 5 belong to the first search result, item numbers 6 to 8 belong to the second search result, and item number 9 belongs to the third search result. The foregoing description has been directed to the configuration of each of the functional units of the document retrieval apparatus 1 according to the second embodiment exemplified as the present embodiment.

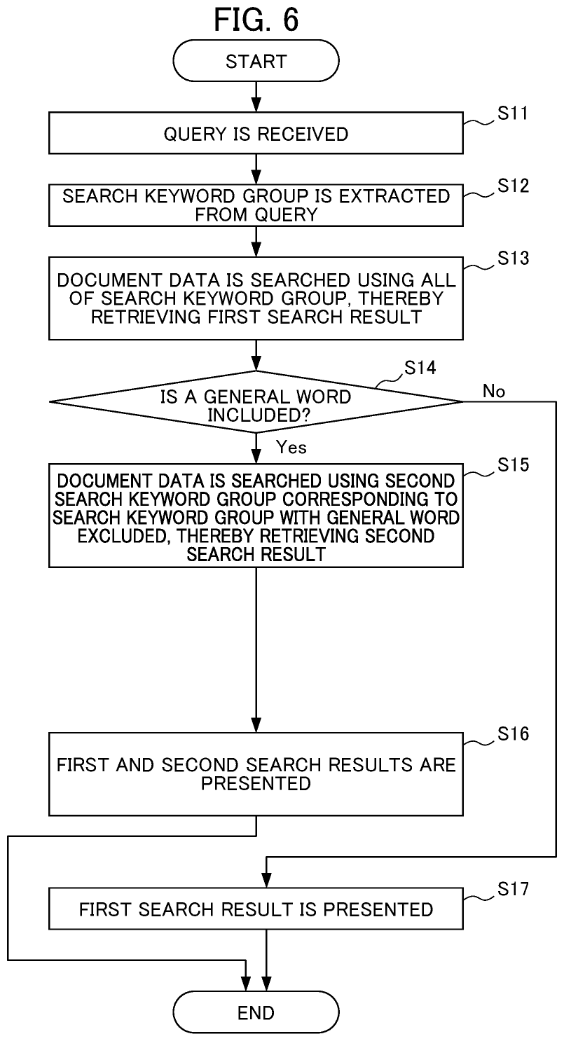

Next, the operation of the document retrieval apparatus 1 in a case where the document retrieval apparatus 1 includes the first search unit 13 and the second search unit 14 will be described with reference to the flowchart of FIG. 6. The flowchart of FIG. 6 shows processing performed by the document retrieval apparatus 1 including the first search unit 13 and the second search unit 14, the processing starting with reception of a query from a user and ending with presentation of search results to the user. In Step S11, the query receiving unit 11 receives, from a user, a query according to which a document as a search target is searched.

In Step S12, the search keyword extraction unit 12 extracts a search keyword group consisting of at least one keyword from the user's query received by the query receiving unit 11 in Step S11.

In Step S13, the first search unit 13 searches the document data 221 stored in the document storage area 22 using a search expression including each of the at least one keyword included in the search keyword group extracted by the search keyword extraction unit 12 in Step S12, and thereby retrieves a first search result.

In Step S14, the second search unit 14 determines whether a general word is included in the search keyword group extracted by the search keyword extraction unit 12 in Step S12. If a general word is included (if the answer is Yes), the process proceeds to Step S15. If no general word is included (it the answer is No), the process proceeds to Step S17.

In Step S15, the second search unit 14 searches the document data 221 stored in the document storage area 22 using a search expression including each of at least one keyword included in a second search keyword group corresponding to the search keyword group with the entirety of the general word excluded, and thereby retrieves a second search result.

In Step S16, the search result presentation unit 16 outputs the first search result and the second search result. However, if the first search result is included in the second search result, the search result presentation unit 16 may exclude the first search result from. the second search result when outputting the second search result. Thereafter, the processing is ended.

In Step S17, the search result presentation. unit 16 outputs the first search result. Thereafter, the processing is ended. The operation of the document retrieval apparatus 1 in the case where the document retrieval apparatus 1 includes the first search unit 13 and the second search unit 14 has been described in the foregoing.

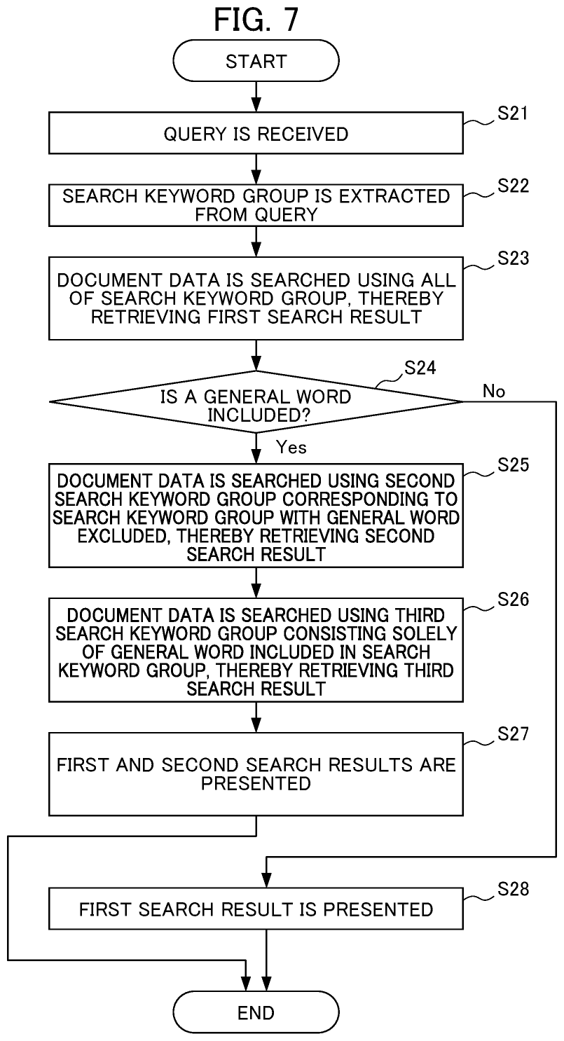

Next, an operation in a case where the document retrieval apparatus 1 includes the third search unit 15 in addition to the first. search unit 13 and the second search unit 14 will be described. FIG. 7 is a flowchart showing processing performed by the document retrieval apparatus 1 including the first search unit 13, the second search unit 14 and the third search unit 15, the processing starting with reception of a query from a user and ending with presentation of search results to the user.

Steps S21 to S25 in FIG. 7 correspond to Steps S11 to S15 in FIG. 6, respectively. It should be noted that Step S2(1≤i≤5) is the same as Step S1i (1≤i≤5) where “i” is the same integer, except that if a determination is made that no general word is included (if the answer is No) in Step S24, the process proceeds to Step S28. Description of the steps that are the same as those described previously will be omitted.

In Step S26, the third search unit 15 searches the document data 221 stored in. the document storage area 22 using a search expression including each of at least one keyword included in a third search keyword group consisting solely of the general word included in the search keyword group, and thereby retrieves a third search result.

In Step S27, the search result presentation unit 16 outputs the first search result, the second search result and the third search result. However, the first search result is included in the second search result, the search result presentation unit 16 may exclude the first search result from the second search result when outputting the second search result. Further, if the first search result is included in the third search result, the search result presentation unit 16 may exclude the first search result from the third search result when outputting the third search result. Thereafter, the processing is ended.

In Step S28, the search result presentation unit 16 outputs the first search result. Thereafter, the processing is ended. The operation of the document retrieval apparatus 1 in the case where the document retrieval apparatus 1 includes the first search unit 13, the second search unit 14 and the third search unit 15 has been described in the foregoing.

The search method of the document retrieval apparatus 1 is implemented with software. To implement the search method with software, programs constituting the software is installed in a computer (i.e., the document retrieval apparatus 1). These programs may be recorded on removable media to be distributed to users, or may be distributed by being downloaded to the users' computers via a network.

<Effects of Present Embodiment>

Embodiments of the present invention are listed below.

(1) According to the present embodiment, the document retrieval apparatus 1 includes: a document storage area 22 configured to store a plurality of document data 221; a general word storage area 21 configured to store a word preset as a general word 211; a query receiving unit 11 configured to receive a query from a user; a search keyword extraction unit 12 configured to extract a search keyword group consisting of at least one keyword from the query; a first search unit 13 configured to search the document data 221 stored in the document storage area 22 using an arbitrary search expression including each of the at least one keyword included in the search keyword group, and thereby to retrieve a first search result; a second search unit 14 configured to, if the search keyword group includes the general word 211, search the document data 221 stored in the document storage area 22 using an arbitrary search expression including each of at least one keyword included in a second search keyword group corresponding to the search keyword group with the entirety of the general word 211 excluded, and thereby to retrieve a second search result; and a search result presentation unit 16 configured to output the first search result and the second search result if the search keyword group includes the general word 211, and to output the first search result if the search keyword group does not include the general word 211. Therefore, when making a query in a natural language to search various document data, the user does not need to be mindful of whether to use a general word as a search keyword, so that the user's workload related to the search is reduced and the user can efficiently retrieve a desired data item from the document data.

(2) The document retrieval apparatus 1 described in (1) may include a third search. unit 15 configured to, if the search keyword group includes the general word 211, search the document data 221 stored in. the document storage area 22 using an arbitrary search expression including each of at least one keyword included in a third search keyword group consisting solely of the general word 211 included in the search keyword group, and thereby to retrieve a third search result, wherein the search result presentation unit 16 may be further configured to output the first search result, the second search result and the third search result if the search keyword group includes the general word 211, and to output the first search result if the search keyword group does not include the general words 211. This feature can exert the following effect, for example. If the number of hits is 0 in both the first search result and the second search result, there is a possibility that the keywords included in the search keyword group extracted by the search keyword extraction unit 12 are not appropriate. In such a case, output of the third search result retrieved using only the general word 211 allows the user to correct, the query words with reference to the third search result and to make a query again.

(3) If the first search result is included in the third search result, the search result presentation unit 16 of the document retrieval apparatus I described in may exclude the first search result from the third search result when outputting the third search result. This feature makes it possible to prevent the same data item of the document data 221 from being displayed in an overlapping manner, and allows the user to find the desired search result with efficiency.

(4) If the first search result is included in the second search result, the search result presentation unit 16 of the document. retrieval apparatus 1 described in (1) to (3) may exclude the first search result from the second search result when outputting the second search result. This feature provides the same effect as in (3).

(5) Further, the search result presentation unit 16 of the document retrieval apparatus 1 described in (1) to (3) may output the first search result at a highest level. This feature in which the search result presentation unit 16 presents the first search. result at the highest level allows the user to easily find the desired data item of the document data.

(6) According to the present embodiment, a document retrieval method executed by a computer includes: a query receiving step of receiving a query from a user; a search keyword extraction step of extracting a search keyword group consisting of at least one keyword from the query; a first search step of searching a plurality of document data 221 stored in a document storage area 22 using an arbitrary search expression including each of the at least one keyword included in the search keyword group, and retrieving a first search result; a second search step of searching the document data 221 stored in the document storage area 22 and retrieving a second search result, the second search step be ng performed if the search keyword group includes a word preset as a general word 211 and stored in a general word storage area 21, the second search step being performed with use of an arbitrary search expression including each of at least one keyword included in a second search keyword group corresponding to the search keyword group with the entirety of the general word 211 excluded; and a search result presenting step of outputting the first search result and the second search result if the search keyword group includes the general word 211, or of outputting the first search result if the search keyword group does not include the general word 211. This feature provides the same effect as in (1).

In the foregoing, the embodiments of the present invention have been described. However, it should be noted that the present invention is not limited to the above-described embodiments. In addition, the effects described in the present embodiments are merely the most favorable effects resulting from the present invention, and the effects of the present invention are not limited to those described in the present embodiment.

[Modification 1]

In the embodiments described above, the document retrieval apparatus 1 is exemplified as an apparatus including the functional units (i.e., the query receiving unit 11, the search keyword extraction unit 12, the first search unit 13, the second search unit 14 and the search result presentation unit 16, and additionally the third search unit 15 in the second embodiment), the document storage area 22 for storing the document data 221, and the general word storage area 21 for storing the general word 211. However, the present invention is not limited thereto. For example, the general word storage area 21 and/or the document storage area 22 may be provided physically independently from the document retrieval apparatus 1, and may be configured as a file server (file device) that is capable of communicating with the document retrieval apparatus 1 via a network or a physical interface. The general word storage area 21 and the document storage area 22 may be configured as file servers (file devices) that are independent from each other. The general word storage area 21 and the document storage area 22 may be provided in a single file server (file device).

Alternatively, the functional units (i.e., the query receiving unit 11, the search keyword extraction unit 12, the first search unit 13, the second search unit 14 and the search result presentation unit 16, and additionally, the third search unit 15 in the second embodiment) constituting the document retrieval apparatus 1 may be distributed appropriately to a plurality of computers (e.g., servers and PCs) that are communicatively connected to each other via a network or a physical interface so as to form a distributed processing system.

For example, a character input device receiving input through a keyboard, a touch panel, or the like may be applied as the query receiving unit 11. Examples of the character input device include a personal computer and a portable terminal. Alternatively, a speech recognition function of a personal computer or a portable terminal may be applied to the query receiving unit 11 so that user's speech is converted into character codes. Alternatively, a handwritten character recognition function of a personal computer or a portable terminal may be applied to the query receiving unit 11 so that user's handwritten characters may be converted into character codes. In these cases, the personal computer or the portable terminal serving as the query receiving unit 11 may be communicatively connected to the other functional units of the document retrieval apparatus 1 via a network or a physical interface. With this configuration, the same computer or the portable terminal may be applied as the search result presentation unit 16. Specifically, the personal computer or the portable terminal serving as the search result presentation unit 16 may output the search results retrieved by the other functional units (e.g., the first search unit 13, the second search unit 14, and the third search unit 15) of the document retrieval apparatus 1 via a screen of the personal computer or a screen of the portable terminal.

Also, the search keyword extraction unit 12, the first search unit 13, the second search unit 14, and the third search unit 15 may be provided in independent physical servers. For example, the first search unit 13, the second search unit 14 and. the third search unit 15 may be communicatively connected to the search keyword extraction unit 12 and the search result presentation unit 16 via a network or a physical interface. The first search unit 13, the second search unit 14 and additionally, the third search unit 15 in the second embodiment may be provided at a location physically separated from the search keyword extraction unit 12 and the search result presentation unit 16. Further, the server device and the file server (file device) described above may be virtual servers on cloud. Such decentralization is a technique known to those skilled in the art and corresponds to a design-choice matter adopted as needed. That is, the functional units and the storage units constituting the document retrieval apparatus 1 can be embodied as a single computer or can be deployed as a plurality of computers interconnected via a communication network and disposed at a single location or distributed to two or more locations.

[Modification 2]

The document data 221 may include one entire document as a set of data. Alternatively, the document data 221 may include one document divided into parts as appropriate. In the case where the document data 221 includes one document divided into parts as appropriate, each of the first search unit 13 and the second search unit 14, and additionally the third search unit 15 in the second embodiment may retrieve a corresponding part of the divided document as a search result. Likewise, the search result presentation unit 16 may present a corresponding part of the divided document as a search result.

### EXPLANATION OF REFERENCE NUMERALS

1: Document Retrieval Apparatus

10: Control Unit

11: Query Receiving Unit

12: Search Keyword Extraction Unit

13: First. Search Unit

14: Second Search Unit

15: Third Search Unit

16: Search Result Presentation Unit

20: Storage Unit

21: General Word Storage Area

211: General Words

22: Document Storage Area

221: Document Data

What is claimed is:

1. A document retrieval apparatus comprising:
a document storage area configured to store a plurality of documents;
a general word storage area configured to store a word preset as a general word;
a query receiving unit configured to receive a query from a user;
a search keyword extraction unit configured to extract a search keyword group consisting of at least one keyword from the query;
a first search unit configured to search the documents stored in the document storage area using a search expression including each of the at least one keyword included in the search keyword group, and thereby to retrieve a first search result;
a second search unit configured to, if the search keyword group includes the general word, search the documents stored in the document storage area using a search expression including each of at least one keyword included in a second search keyword group corresponding to the search keyword group with entirety of the general word excluded, and thereby to retrieve a second search result; and
a search result presentation unit configured to output the first search result and the second search result if the search keyword group includes the general word, and to output the first search result if the search keyword group does not include the general word.

2. The document retrieval apparatus according to claim 1, further comprising:
a third search unit configured to, if the search keyword group includes the general word, search the documents stored in the document storage area using a search expression including each of at least one keyword included in a third search keyword group consisting solely of the general word included in the search keyword group, and thereby to retrieve a third search result,
wherein the search result presentation unit is further configured
to output the first search result, the second search result and the third search result if the search keyword group includes the general word, and
to output the first search result if the search keyword group does not include the general word.

3. The document retrieval apparatus according to claim 2, wherein
if the first search result is included is the third search result, the search result presentation unit excludes the first search result from the third search result when outputting the third search result.

4. The document retrieval apparatus according to claim 1, wherein
if the first search result is included is the second search result, the search result presentation unit excludes the first search result from the second search result when outputting the second search result.

5. The document retrieval apparatus according to claim 1, wherein
the search result presentation unit outputs the first search result at a highest level.

6. A document retrieval method executed by a computer, the method comprising:
a query receiving step of receiving a query from a user;
a search keyword extraction step of extracting a search keyword group consisting of at least one keyword from the query;
a first search step of searching a plurality of documents stored in a document storage area using a search expression including each of the at least one keyword included in the search keyword group, and retrieving a first search result;
a second search step of searching the documents stored in the document storage area and retrieving a second search result, the second search step being performed if the search keyword group includes a word preset as a general word and stored in a general word storage area, the second search step being performed with use of a search expression including each of at least one keyword included in a second search keyword group corresponding to the search keyword group with entirety of the general word excluded; and
a search. result presenting step of outputting the first search result and the second search result if the search keyword group includes the general word, or of outputting the first search result if the search keyword group does not include the general word.
